(19) United States
(12) Patent Application Publication
(10) Pub. No.: US 2019/0089065 A1
(43) Pub. Date: Mar. 21, 2019

(54) Apparatus with rectangular waveguide to radial mode transition

(71) Applicant: Kymeta Corporation, Redmond, WA (US)

(72) Inventors: Benjamin SIKES, Seattle, WA (US); Mike SLOTA, Kirkland, WA (US); Anthony Guenterberg, Puyallup, WA (US); Mohsen SAZEGAR, Kirkland, WA (US); Chris EYLANDER, Redmond, WA (US); Bradley EYLANDER, Kent, WA (US)

(21) Appl. No.: 15/999,703

(22) Filed: Aug. 20, 2018

Related U.S. Application Data
(60) Provisional application No. 62/548,275, filed on Aug. 21, 2017.

(51) Int. Cl. H01Q 21/00; H01Q 21/06; H01Q 3/24; H01Q 1/48; H01Q 13/10

(52) U.S. Cl. CPC H01Q 21/0012; H01Q 21/0031; H01Q 21/005; H01Q 13/103; H01Q 3/24; H01Q 1/48; H01Q 21/065

(57) ABSTRACT

An apparatus with a rectangular waveguide to radial mode transition and method for using the same are described. In one embodiment, the apparatus comprises a radial waveguide having at least one plate; a radio-frequency (RF) launch coupled to the radial waveguide comprising a rectangular waveguide, a rectangular waveguide to coaxial transition coupled to the rectangular waveguide, and a coaxial to radial transition coupled to the rectangular waveguide to coaxial transition.

### PRIORITY

The present patent application claims priority to and incorporates by reference the corresponding provisional patent application Ser. No. 62/548,275, titled, “Rectangular Waveguide to Radial Mode Transition,” filed on Aug. 21, 2017.

### FIELD OF THE INVENTION

Embodiments of the present invention relate to the field of wireless communication; more particularly, embodiments of the present invention relate to antennas having a radio-frequency (RF) launch with a transition between two modes of RF transmission.

### BACKGROUND OF THE INVENTION

High gain antennas, used in applications such as satellite communications (SATCOM), or line-of-sight (LOS) communications links, require large aperture areas to achieve sufficiently high gains. The gains for the antennas are often achieved by directing RF energy to an antenna feed.

One problem with a conventional antenna feed is that each of the components, e.g., input section, polarizer, is generally constructed as a separate component. For example, in some antennas, the antenna input is a commercial SMA connector and the interface to the diplexer is via a waveguide, which necessitates a commercial waveguide to SMA adapter. Thus, an extra piece of hardware is needed to transition between coax and a waveguide.

The assembly, testing and fine tuning of such separately manufactured antenna feeds results in significant labor and manufacturing cost, long fabrication and test times, and potential for high variability of antenna performance between units.

### SUMMARY OF THE INVENTION

An apparatus with a rectangular waveguide to radial mode transition and method for using the same are described. In one embodiment, the apparatus comprises a radial waveguide having at least one plate; a radio-frequency (RF) launch coupled to the radial waveguide comprising a rectangular waveguide, a rectangular waveguide to coaxial transition coupled to the rectangular waveguide, and a coaxial to radial transition coupled to the rectangular waveguide to coaxial transition.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 illustrates one embodiment of an antenna RF launch with a two mode transition between two modes of RF energy propagation.

FIGS. 2A and 2B illustrate a side view of one embodiment of an antenna containing an RF launch.

FIGS. 3A and 3B illustrate radial and coaxial modes of RF propagation, respectively.

FIG. 3C illustrates the direction of propagation in a rectangular (e.g., TE10) waveguide.

FIG. 4 illustrates cross-section view of one embodiment of an RF launch in relation to the waveguide of one embodiment of an antenna.

FIG. 5A illustrates one embodiment of a rectangular waveguide to coaxial stepped transition.

FIG. 5B illustrates one embodiment of a coaxial to radial transition.

FIG. 5C illustrates the coupling of the coaxial to radial transition and the rectangular waveguide to coaxial stepped transition.

FIG. 5D illustrates the coaxial to radial transition coupled to the rectangular waveguide to coaxial stepped transition.

FIGS. 5E and 5F illustrate one embodiment of the rectangular waveguide interface.

FIGS. 6A and 6B illustrate alternative embodiments of a launch for the coaxial to radial transition.

FIG. 7A illustrates the schematic of one embodiment of a cylindrically fed holographic radial aperture antenna.

FIG. 7B illustrates a perspective view of one row of antenna elements that includes a ground plane and a reconfigurable resonator layer.

FIG. 8A illustrates one embodiment of a tunable resonator/slot.

FIG. 8B illustrates a cross section view of one embodiment of a physical antenna aperture.

FIGS. 9A-D illustrate one embodiment of the different layers for creating the slotted array.

FIG. 10 illustrates a side view of one embodiment of a cylindrically fed antenna structure.

FIG. 11 illustrates another embodiment of the antenna system with an outgoing wave.

FIG. 12 illustrates one embodiment of the placement of matrix drive circuitry with respect to antenna elements.

FIG. 13 illustrates one embodiment of a TFT package.

FIG. 14 is a block diagram of one embodiment of a communication system having simultaneous transmit and receive paths.

FIG. 15 illustrates one embodiment of an alternative RF launch with a metallic radial stub.

FIG. 16 illustrates one embodiment of an alternative RF launch with a waveguide stepped transition.

FIG. 17 illustrates one embodiment of an RF launch with a stripline transition.

### DETAILED DESCRIPTION

An antenna having a radio-frequency (RF) launch with a transition between two modes of RF energy propagation and a method of using the same are disclosed. The transition provides a transformation between two modes of RF energy propagation. In one embodiment, the mode transformation is between a rectangular waveguide mode and radial propagating mode for the antenna. In one embodiment, the rectangular waveguide mode is a waveguide TE10 mode.

In one embodiment, the antenna comprises a metamaterial surface antenna having a cylindrical feed, such as described, for example, in more detail below. In one embodiment, the antenna elements of such an antenna is fed with RF energy from the RF launch with a radial propagating mode, and the RF energy is fed into the RF launch via a rectangular waveguide which is driven by commercial diplexers and RF amplification circuits.

Embodiments of the RF launch described herein have one or more advantages. One or more advantages include that the transition allows a more integrated waveguide structure with fewer discrete parts, a more compact assembly and a repeatable assembly process. That is, the RF launch disclosed herein eliminates the waveguide to SMA adapter of the prior art and changes the antenna input to the waveguide to interface directly to a diplexer. Embodiments of the RF launch also lower the loss of using more discrete components, e.g. waveguide to SMA transition, then SMA to radial transition.

Transition from TE10 Rectangular Waveguide (Mode) to Radial Propagating Mode

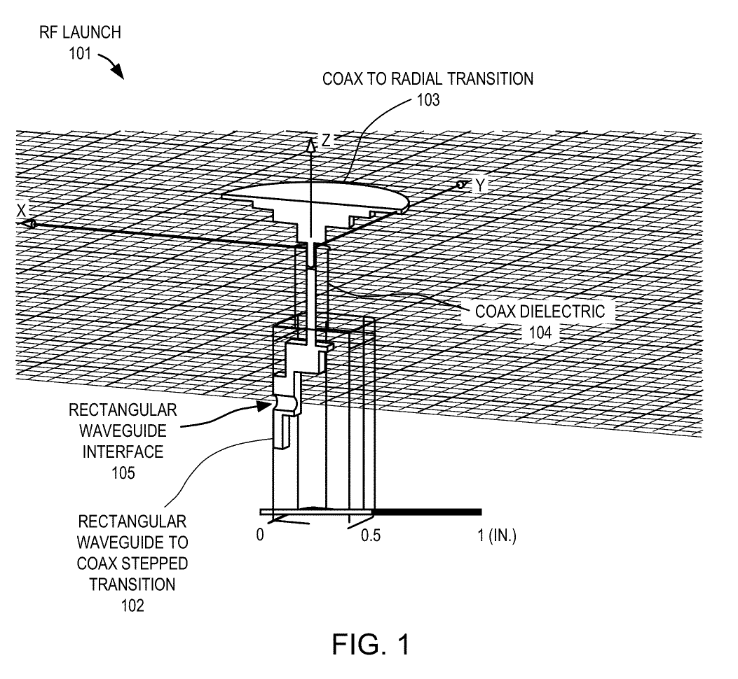

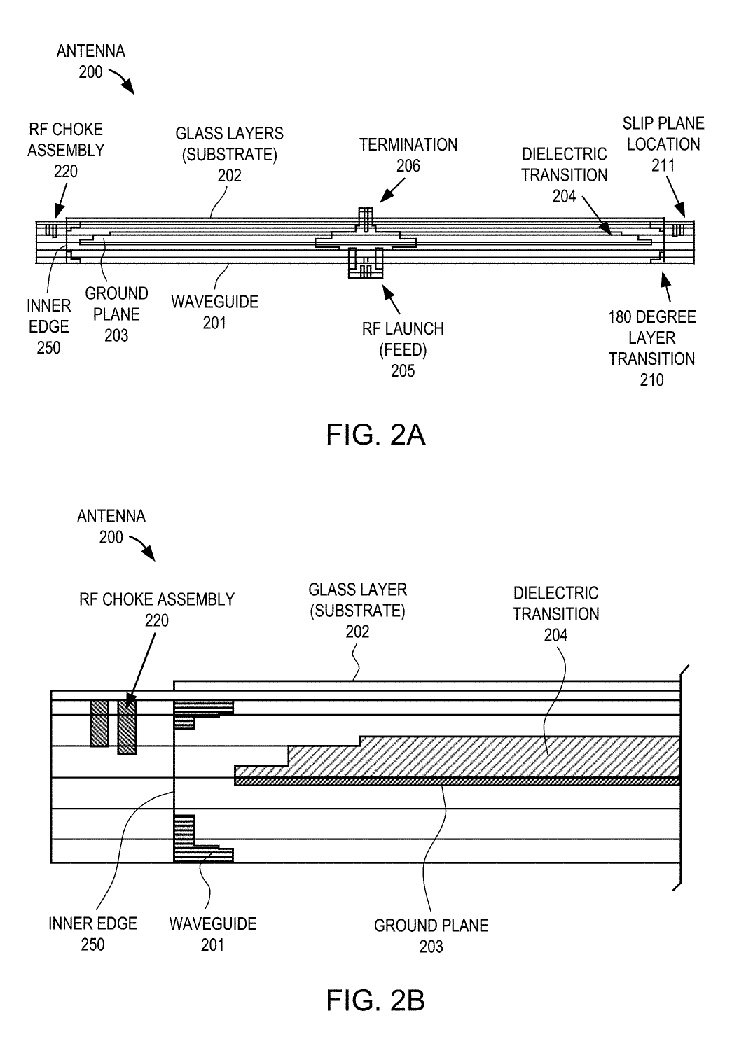

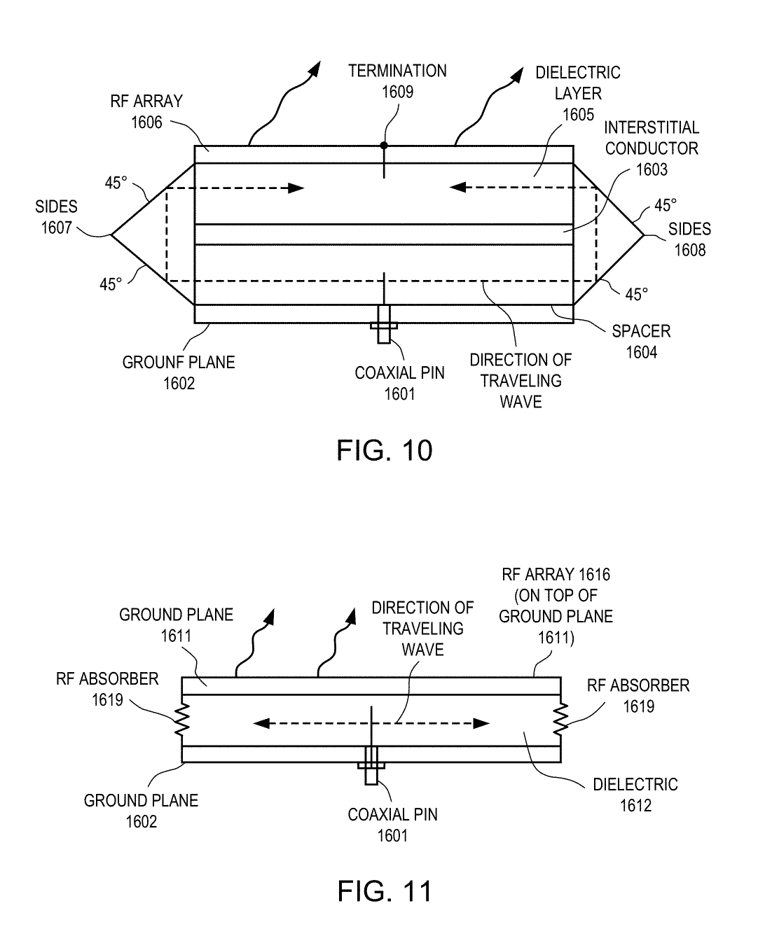

FIG. 1 illustrates one embodiment of an antenna RF launch with a two-mode transition between two modes of RF energy propagation, namely a rectangular waveguide (mode) to a radial propagating mode. In one embodiment, the antenna includes a radial waveguide having at least one plate. In one embodiment, the radial waveguide is a parallel plate waveguide such as shown in FIGS. 2A and 2B or FIG. 10.

Referring to FIG. 1, the RF launch 101 is coupled to the radial waveguide (not shown) and comprises a coaxial to radial transition 103, a rectangular waveguide to coaxial stepped transition 102 coupled to coaxial to radial transition 103, and a rectangular waveguide coupled to rectangular waveguide to coaxial stepped transition 102 via rectangular waveguide interface 105. In one embodiment, the coaxial to radial transition 103 comprises an interface shaped into concentric tiers. In one embodiment, the parts of RF launch 101 operate together to improve, or even maximize, the transfer of energy, while reducing, or even minimizing, RF energy reflection.

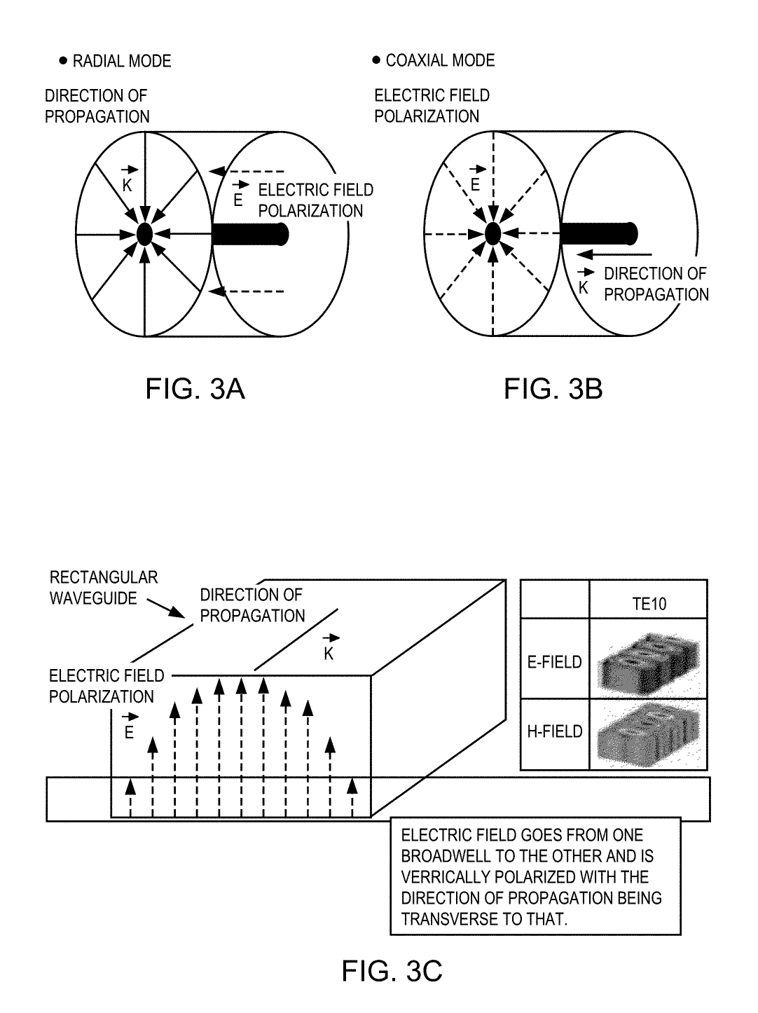

In one embodiment, the rectangular waveguide has a radial non-symmetric mode and coaxial to radial transition 103 has a radial symmetric mode. The radial and coaxial modes of RF propagation are shown in FIGS. 3A and 3B, respectively. In both modes, the direction of propagation is traverse to the polarization of the electric field. FIG. 3C illustrates the direction of propagation in a rectangular (e.g., TE10) waveguide. Referring to FIG. 3C, the electric field from one broad wall to the other is vertically polarized, with the direction of propagation being transverse to that.

As shown in greater detail below, in one embodiment, the rectangular waveguide to coaxial stepped transition 102 is coupled to the rectangular waveguide at a 90° angle. This is advantageous as the transition is low profile and the match is in a direction normal to the launch interface. However, in alternative embodiments, the coupling can be at an angle other than a 90° angle.

In one embodiment, the coaxial to radial transition 103 has a coaxial waveguide dielectric 104 that surrounds the coupling between coaxial to radial transition 103 and rectangular waveguide to coaxial stepped transition 102. In one embodiment, coaxial waveguide dielectric 104 has a dielectric constant that is higher than air.

In one embodiment, the rectangular waveguide to coaxial stepped transition 102 is coupled to the coaxial to radial transition 103 via a pin (e.g., a press fit pin). In one embodiment, the coaxial to radial transition 103 has the pin and the pin is fit in a pin receptacle of rectangular waveguide to coaxial stepped transition 102. In one embodiment, the coaxial waveguide dielectric 104 is configured to maintain the pin of the coaxial to radial transition 103 in a centered (perpendicular) position with respect to the coaxial to radial transition 103.

FIGS. 2A and 2B illustrate a side view of one embodiment of an antenna containing an RF launch, such as described, for example, in FIG. 1. Referring to FIGS. 2A and 2B, antenna 200 includes a radial waveguide 201, an aperture consisting of a substrate or glass layers (panels) 202 with antenna elements (not shown), a ground plane 203, a dielectric (or other layer) transition 204, an RF launch (feed) 205 and a termination 206. Note that while in one embodiment glass layers 202 comprises two glass layers, in other embodiments, the radiating aperture comprises only one glass layer or a substrate with only one layer. Alternatively, the radiating aperture comprises more than two layers that operate together to radiate RF energy (e.g., a beam).

In one embodiment, the aperture consisting of glass layers (substrate) 202 with antenna elements is operable to radiate radio frequency (RF) signals in response to an RF feed wave fed from RF launch 205 that travels from the central location of RF launch 205 along radial waveguide 201 around ground plane 203 (that acts as a guide plate) and 180° layer transition 210 to glass layers 202 to radiating aperture at the top portion of antenna 200. Using the RF energy, the antenna elements of glass layers 202 radiate RF energy. In one embodiment, the RF energy radiated by glass layers in response to the RF energy from the feed wave is in the form of a beam.

In one embodiment, glass layers (or other substrate) 202 is manufactured using commercial television manufacturing techniques and does not have electrically conductive metal at the most external layer. This lack of conductive media on the external layer of the radiating aperture prevents a physical electrical connection between the subassemblies without further invasive processing of the subassemblies. To provide a connection between glass layers 202 that form the radiating aperture and waveguide 201 that feeds the feed wave to glass layers 202, an equivalent RF connection is made to prevent radiation from the connection seam. That is, RF choke assembly RF choke 220 is operable to block RF energy from exiting through a gap between outer portions of waveguide 201 and glass layers 202 that form the radiating aperture. In addition, the difference in the coefficient of thermal expansion of glass layers 202 and feed structure material of waveguide 201 necessitates the need for an intermediate low-friction surface to ensure free planar expansion of the antenna media.

Because the glass layers 202 forming the radiating aperture and waveguide housing are made of different materials with different coefficients of thermal expansion, there is some accommodation made at the extents of the housing of waveguide 201 to allow for physical movement as temperatures vary. To allow for free movement of glass layers 202 and waveguide 201 housing without physically damaging either structure, the glass layers 202 are not permanently bonded to waveguide 201. In one embodiment, glass layers 202 are held mechanically in close intimate contact with waveguide 201 by clamping type features. That is, to hold glass layers 202 generally in position with respect to waveguide 201 in view of their differences in the coefficient of thermal expansion, a clamping mechanism is included.

In one embodiment, beneath the clamp features are materials to isolate the clamp from glass layers 202 (i.e., foam, additional thin film or both). An intermediate material with lower friction resistance is added between the aperture and feed to act as a slip plane. The slip plane allows the glass to move laterally. In one embodiment, as discussed above, this may be useful for thermal expansion or thermal mismatch between layers. FIG. 2A illustrates an example of the slip plane location 211.

In one embodiment, the material is thin film in nature and of a plastic material such as, for example, Acrylic, Acetate, or Polycarbonate and is adhered to the underside of the glass or top of the housing of waveguide 201. In addition to cushioning glass layers 202 and providing a slip plane to waveguide 201, the thin sheet material when attached to the glass provides some additional structural support and scratch resistance to the glass. The attachment may be made using an adhesive.

In one embodiment, the radial feed is designed such that each individual component can operate over a large bandwidth, i.e., >50% bandwidth. The constituent components that make up the feed are: RF launch 205, 180° layer transition 210, termination 206, intermediate ground plane 203 (guide-plate), the dielectric loading of dielectric transition 204, and RF choke assembly 220.

In one embodiment, RF launch 205 has a stepped transition from the input (co)axial mode (direction of propagation is through the conductor) to the radial mode (direction of propagation of the RF wave occurs from the edges of the conductor toward its center). This transition shorts the input pin to a capacitive step that compensates for the probe inductance, then impedance steps out to the full height of radial waveguide 201. The number of steps needed to transition is related to the desired bandwidth of operation and the difference between the initial impedance of the launch and the final impedance of the guide. For example, in one embodiment, for a 10% change in bandwidth, a one-step transition is used; for a 20% change in bandwidth, a two-step transition is used; and for a 50% change in bandwidth, a three (or more) step transition is used.

Shorting the pin to ground plane 203 (the top plate of waveguide 201) allows for higher operating power levels by conducting generated heat away from the center pin of RF launch 205 into the housing of waveguide 201 which in one embodiment is metal (e.g., aluminum, copper, brass, gold, etc.). Any risk of dielectric breakdown is reduced by controlling the gaps between the stepped RF launch 205 and the bottom of the housing of waveguide 201 and breaking the sharp edges at the impedance steps.

The top termination transition of RF launch 205 is designed in the same manner with impedance compensation added for the presence of the slow wave dielectric material. By designing the impedance transitions using discrete steps, RF launch 205 is easily manufactured using a three-axis computer numeric control (CNC) end mil.

In one embodiment, 180° layer transition 210 is accomplished in a similar manner to the launch and termination design. In one embodiment, a chamfer or single step is used to compensate for the inductance of the 90° bends. In another embodiment, multiple steps are used and can individually be tuned to accomplish a broadband match. In one embodiment, the slow wave dielectric transition 204 of the top waveguide is placed at the top 90° bend, thus adding asymmetry to the full 180° transition. This dielectric presence can be compensated for by adding asymmetry to the top and bottom transition steps.

The equivalent RF grounding connection is accomplished by adding RF choke assembly 220 to the feed waveguide/glass interface such that the RF energy within the intended frequency band is reflected from RF choke assembly 220 interface without radiating into free space, and in-turn adding constructively with the propagating feed signal. In one embodiment, these chokes are based on traditional waveguide choke flanges that help ensure robust RF connection for high power applications. Such chokes may also be based on electromagnetic band gap (EBG) structures as described in further detail below. Several RF chokes can be added in series to provide a broadband choke arrangement for use at transmit and receive bands simultaneously.

In one embodiment, RF choke assembly 220 includes waveguide style chokes having one or more slots, or channels, that are integrated into waveguide 201. FIGS. 2A and 2B illustrate two slots. Note that in one embodiment as waveguide 201 is radial, the slots are rings that are inside the top of waveguide 201. In one embodiment, the slots are designed to be placed at an odd integer multiple of a quarter wavelength (e.g., ¼, ¾, 5/4, etc.) from the inside of the RF feed junction (i.e., the outer most edge of the inner portion of waveguide 201 through which the feed wave propagates, shown as inner edge 250 in FIG. 2A). In one embodiment, the choke channels are also one quarter of a wavelength deep such that the reflected power is in phase at the top of the choke channel. In one embodiment, the total phase length of the choke assembly will in turn be out of phase with the propagating feed signal, which gives the choke assembly (e.g., between the top and bottom of the slot(s)) the equivalent RF performance of an electrical short. This electrical short equivalence maintains the continuity of the feed structure walls without the need for a physical electrical connection.

Note that two choke slots (channels) may be used for each frequency band of the feed wave. For example, two choke slots may be used for one receive frequency band while another two slots are used for a different receive frequency band or a transmit frequency band. For example, transmit and receive frequency bands may be Ka transmit and receive frequency bands, respectively. For another example, the two receive frequency bands may be the Ka and Ku frequency bands, or any band in which communication occurs. The spacing of the slots is the same as above. That is, the slots would be designed to be placed at an odd integer multiple of a quarter wavelength (e.g., ¼, ¾, 5/4, etc.) from the inside of the RF feed junction (e.g., inner edge 250) to create a low impedance short. In one embodiment, the slots of ¼λ deep with a width sized for high impedance (where the λ is that of the frequency to be blocked). While each of the slots resonate at one frequency (to block energy at that frequency), the choke will likely block a band of frequencies. For example, while the slots resonate at one frequency of the Ku band, the choke covers the entire Ku band.

### Cross-Section Views of RF Launch

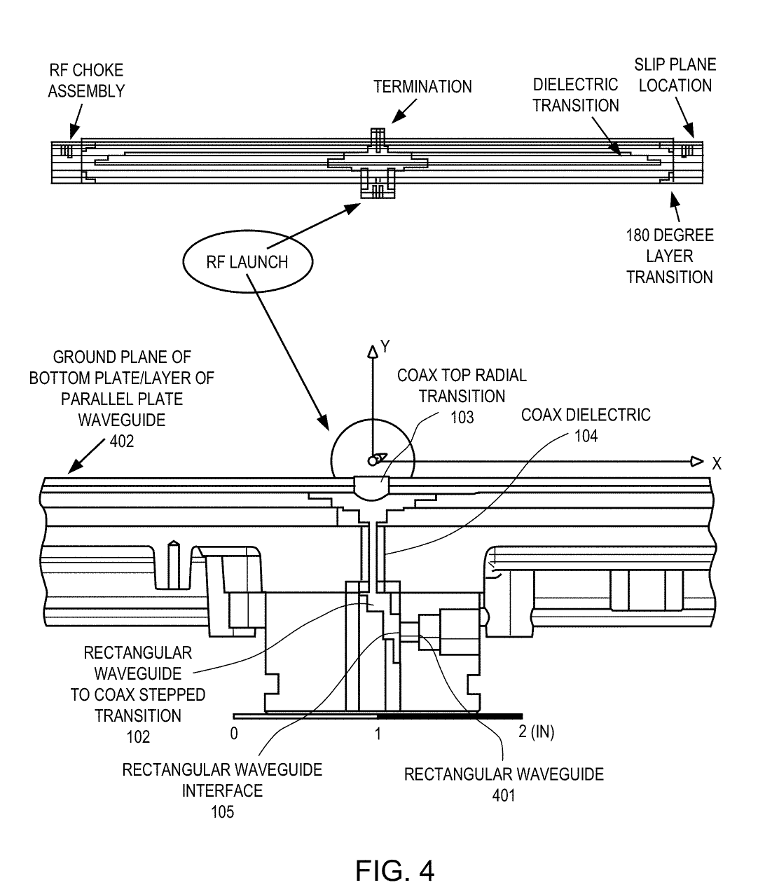

FIG. 4 illustrates cross-section view of one embodiment of an RF launch in relation to the waveguide of one embodiment of an antenna. The antenna may be any flat panel antenna, including, for example, those described in more detail below.

Referring to FIG. 4, coaxial to radial transition 103 is coupled to a rectangular waveguide to coaxial transition 102. In one embodiment, rectangular waveguide to coaxial transition 102 comprises a rectangular waveguide to coaxial stepped transition 102. Rectangular waveguide to coaxial transition 102 is coupled to rectangular waveguide 401. Coaxial to radial transition 103 is coupled to the waveguide of an apparatus. In one embodiment, the apparatus comprises an antenna, such as, for example, the antenna shown in FIGS. 2A and 2B or an antenna described in more detail herein. In one embodiment, coaxial to radial transition 103 has a coaxial transmission line with a dielectric constant that is higher than air

The coaxial transmission line dielectric 104 is shown surrounding the coaxial interface between coaxial to radial transition 103 and a rectangular waveguide to coaxial stepped transition 102. In one embodiment, coaxial transmission line dielectric 104 is polytetraflouroethylene (PTFE).

In one embodiment, the top of coaxial to radial transition 103 aligns with the ground plane of the bottom plate/layer 402 of a parallel plate waveguide.

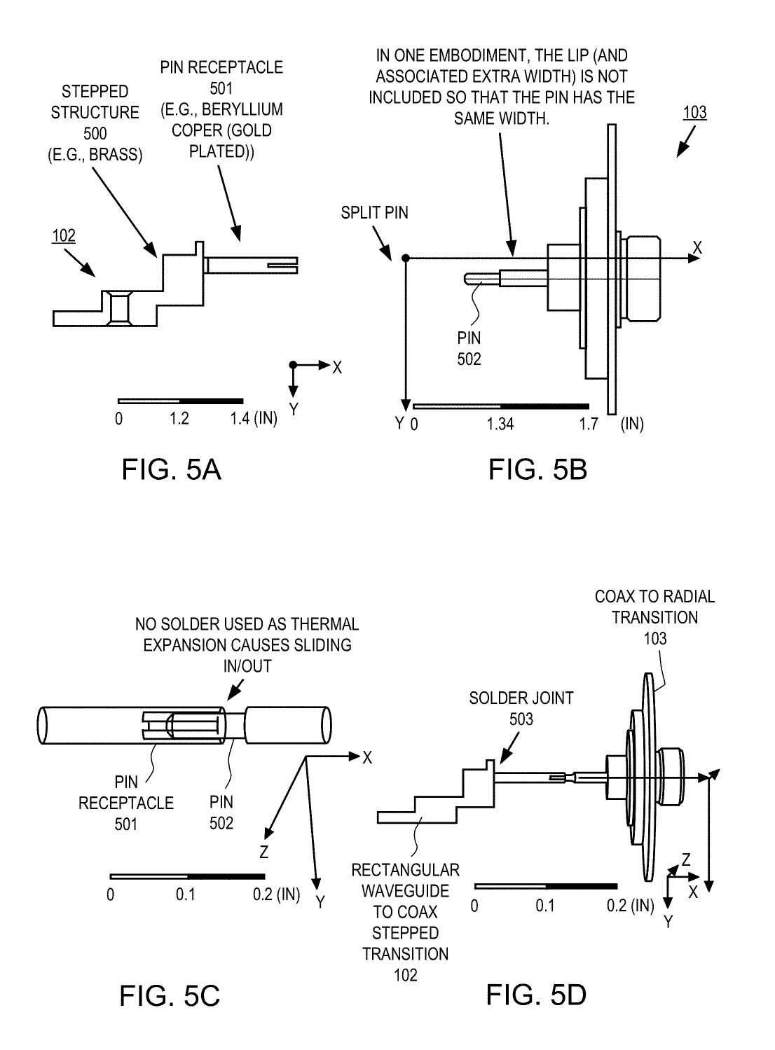

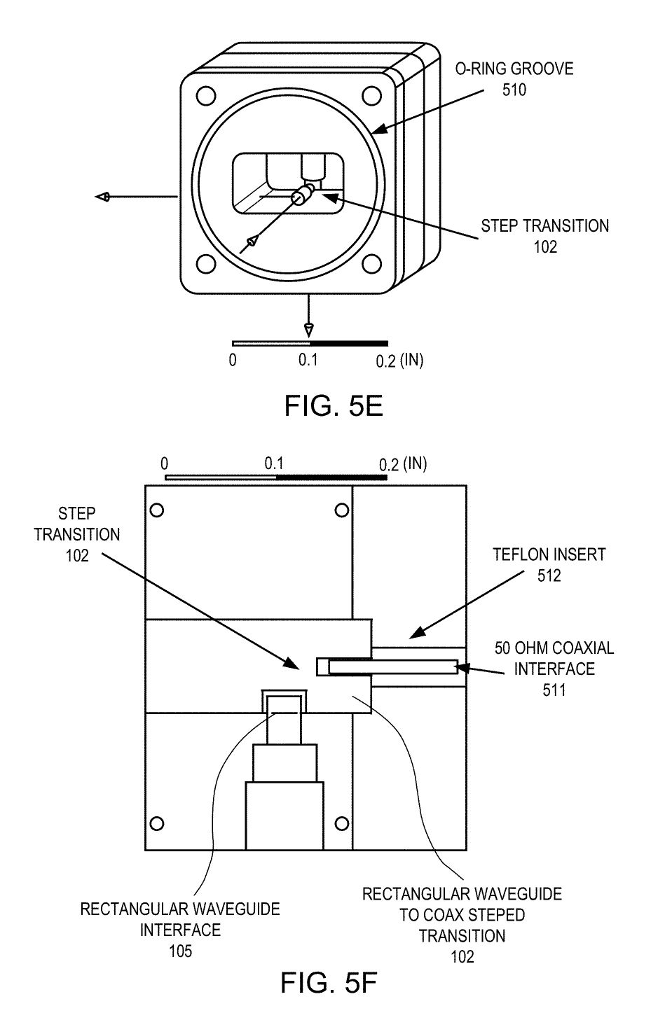

FIG. 5A illustrates one embodiment of a rectangular waveguide to coaxial stepped transition. Referring to FIG. 5A, the rectangular waveguide to coaxial stepped transition includes three steps. In an alternative embodiment, the rectangular waveguide to coaxial stepped transition has as stepped structure 500 and a pin receptacle 501. In one embodiment, stepped structure 500 is coupled to pin receptacle 501 via a solder joint (e.g., solder joint 503 of FIG. 5D).

In one embodiment, stepped structure 500 includes three steps. In an alternative embodiment, stepped structure 500 includes four steps. The number of steps may be greater than four or less than three. The number of steps and step size is selected based on the frequency of the RF energy propagating through the rectangular waveguide to coaxial stepped transition to achieve no more than a predetermined amount of loss and no more than a predetermined amount of reflection. In one embodiment, each step has a capacitive component and an inductive component that can be set in a well-known manner through circuit modeling to set the length and width of the steps to achieve a desired amount of energy transfer and reduced reflection. Note that the number of steps increases if a larger bandwidth is desired.

In one embodiment, the stepped structure is made from brass. However, any good conductor may be used, such as, for example, copper, aluminum, or any other easily-machined, yet high-conductivity metal.

Pin receptacle 501 is designed to receive a pin of the coaxial to radial transition 103, such as shown pin 502 in FIG. 5B. In one embodiment, pin 502 is a split, or press fit pin. In one embodiment, pin receptacle is made from a highly conductive material, such as, a metallic material like, for example, Beryllium copper (gold plated), aluminum, magnesium, etc.

FIG. 5B illustrates one embodiment of a coaxial to radial transition. Referring to FIG. 5B, pin 502 includes a lip that has an extra width. In other words, pin 502 has a first, smaller width at the end that is inserted into the pin receptacle of the rectangular waveguide to coaxial stepped transition than the width of pin 502 closer to the body of the coaxial to radial transition. In one embodiment, the width of the lip is the same diameter as that of the receptacle. However, this is not required. A larger lip may provide more mechanical strength for the pin since the part connecting to the coaxial to radial transition has a larger diameter. A larger lip might help the transfer of heat from the pin to the coaxial to radial transition for very high power scenarios. In one embodiment, the lip (and its associated extra width) is not included, so that pin 502 has the same uniform width.

FIG. 5C illustrates the coupling of the coaxial to radial transition and the rectangular waveguide to coax stepped transition. Referring to FIG. 5C, pin 502 of the coaxial to radial transition is inserted in pin receptacle 501 of the rectangular waveguide to coaxial stepped transition. In one embodiment, pin 502 slides in and out of pin receptacle 501 due to thermal expansion during antenna operation. Thus, the coupling of the coaxial to radial transition and the rectangular waveguide to coaxial stepped transition is not via solder or any other attachment mechanism that prevents pin 502 from sliding in and out of pin receptacle 501.

FIG. 5D illustrates the coaxial to radial transition coupled to the rectangular waveguide to coaxial stepped transition.

FIGS. 5E and 5F illustrate one embodiment of the rectangular waveguide interface. Referring to FIGS. 5E and 5F, the rectangular waveguide interface includes an O-ring groove 510 and a slot to the rectangular waveguide to coaxial stepped transition 102. In one embodiment, a coaxial interface 511 between the rectangular waveguide to coaxial stepped transition 102 and the coaxial to radial transition has a PTFE (or other insulating material) insert (coaxial dielectric) 512. Other materials may be used in place of Teflon. In one embodiment, the coaxial dielectric 512 has a higher dielectric than air and keeps the pin (e.g., pin 502 of depicted in FIGS. 5B and 5C) centered with respect to its connection between the coaxial to radial transition and the rectangular waveguide to coaxial stepped transition and with respect its interface on the coaxial to radial transition.

In an alternative embodiment, rather than metallic pins and machined metal transitions, circuit boards are used to transition from waveguide to radial mode (i.e., two modes of RF propagation). In such a case, the circuit board replaces the coaxial center conductor, the stepped transitions of the waveguide and the radial transition.

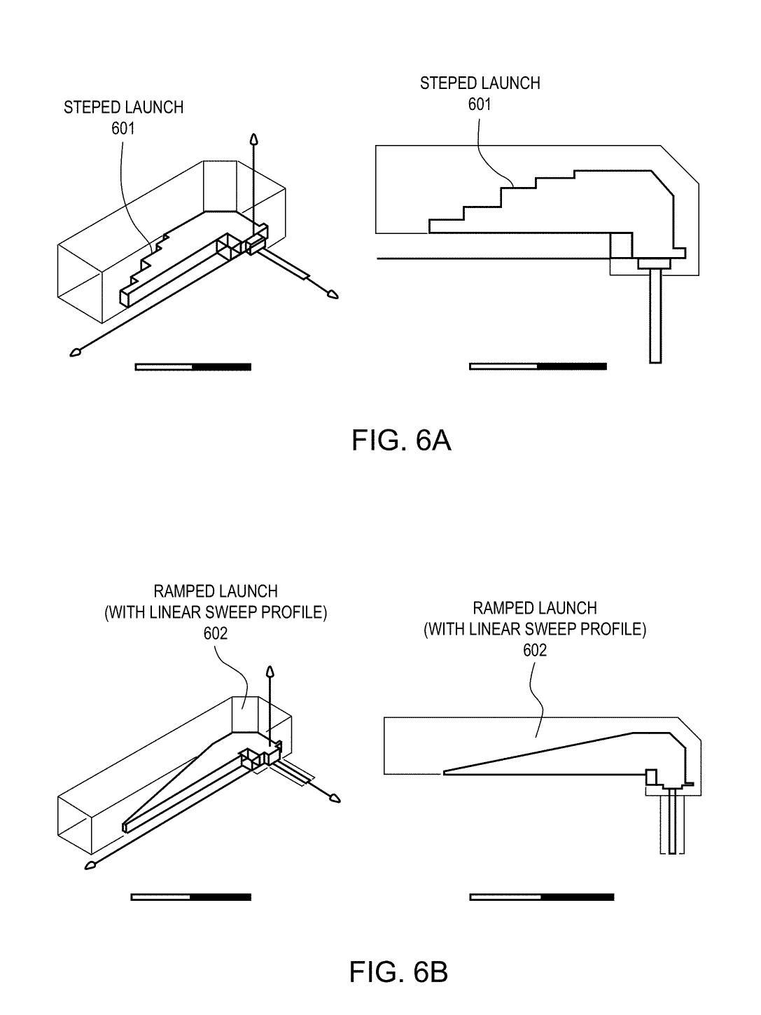

FIGS. 6A and 6B illustrate alternative embodiments of a launch for the coaxial to radial transition. FIG. 6A illustrates a 90° bend, stepped launch 601 with 4 steps. In one embodiment, stepped launch 601 has a return loss greater than 25 dB from 11 GHz to 14 GHz. Note that the number of steps may be more or less than four. FIG. 6B illustrates a 90° bend, ramped launch. Referring to FIG. 6B, ramped launch 602 includes a linear sweep profile. In one embodiment, ramped launch 602 has a return loss greater than 20 dB over a 10 GHz to 14.85 GHz band. The size of the ramp, including the length of the ramp and its height, to achieve the desired return loss and reflection profiles.

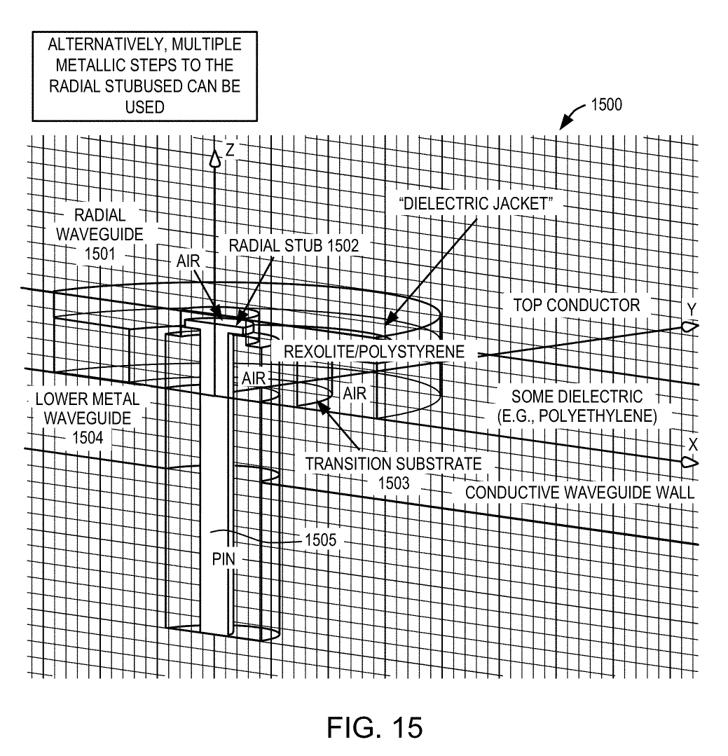

FIG. 15 illustrates one embodiment of an alternative RF launch with a metallic radial stub. Referring to FIG. 15, a radial waveguide 1501 is coupled to lower metal waveguide 1504. A transition substrate 1503 is shown between radial waveguide 1501 is coupled to lower metal waveguide 1504. A pin 1505 is used to transfer RF energy to radial stub 1502, which transfers the energy into radial waveguide 1501. In one embodiment, there is a single step to radial stub 1502. In alternative embodiments, there are multiple steps to the radial stub. Note that in one embodiment, a coaxial dielectric, such as, for example, described above, is around pin 1505.

The probe, pin 1505, extruding from the coax creates a time-varying electric field which propagates down the radial waveguide 1501. In one embodiment, radial stub 1502 is etched or attached to the top of pin 1505 and the substrate transition 1503 aka a dielectric jacket

In one embodiment, the wave impedance (Zw) coming from the coax is primarily inductive and 50 Ohms and radial waveguide 1501 is capacitive with low impedance as give by the equation immediately below:

$$Impdance , Z = \sqrt{\frac{{μ}_{0} * {μ}_{r}}{{ɛ}_{0} * {ɛ}_{r}}} * \frac{waveguide height}{waveguide length} Ω$$

Therefore, in such a case, transition 1503 transforms the wave impedance from inductive to capacitive and a 50 ohm impedance to the impedance of a radial waveguide (radial waveguide, Z<<impedance of coax, 50 Ohms).

Radial stub 1502 increases the capacitance of the transition from the coax (which is primarily inductive) to provide a better match as the wave needs to be more capacitive to account for the impedance of the radial waveguide.

The increased area provided by radial stub 1502 increases the capacitance of the transition such as provided with the equation below:

$$Capacitance = {ɛ}_{0} * \frac{Area}{Distance}$$

As can be seen from this equation, the distance from the top of the waveguide to pin 1502 should be decreased in increase capacitance, and due to manufacturing limitations this value should be as high as possible.

To shorten pin 1505 to a manufacturable and repeatable length (decreasing ‘distance’), one can add a higher dielectric material (increasing ε₀) to increase the capacitance—this was done with the substrate transition 1503.

In one embodiment, rexolite/polystyrene is used for substrate transition 1503 (dielectric constant=2.53) because it's low loss, plentiful, cheap, and structurally rigid (easy to manufacture and add features).

Having a dielectric layer above pin 1505 could also improve capacitance (improve match as well). Alternatively, if there are mechanical limitations, in one embodiment, air is used.

In addition to the single stub, additional steps below pin 1505 could be added to create a better match and increase bandwidth.

In one embodiment, transition substrate 1503 has a combination of substrates with different dielectric constants to provide better matching.

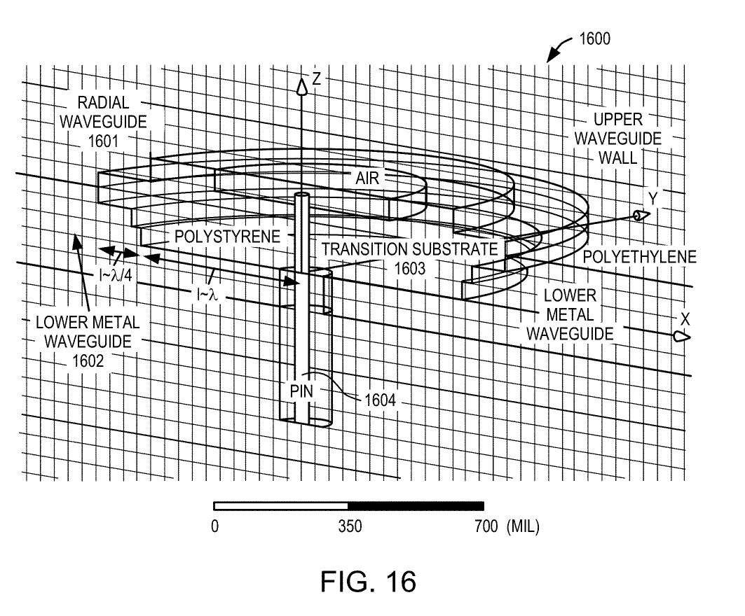

FIG. 16 illustrates one embodiment of an alternative RF launch with a waveguide stepped transition. Referring to FIG. 16, a radial waveguide 1601 is coupled to lower metal waveguide 1602. A transition substrate 1603 is shown between radial waveguide 1601 is coupled to lower metal waveguide 1602. A pin 1604 is used to transfer RF energy to into radial waveguide 1601. A number of steps 1605 are embedded in the waveguide that lead up to radial waveguide 1601. Note that in one embodiment, a coaxial dielectric, such as, for example, described above, is around pin 1604.

The probe, pin 1604, extruding from the coax creates a time-varying electric field which propagates down the radial waveguide 1601.

In the RF launch 1600, the steps that lead up to radial waveguide 1601 and substrate transition 1603 aka a dielectric jacket are important. As described previously, a goal of the RF launch is to create a transition that is capacitive and low impedance in order to match the impedance of radial waveguide 1601.

In one embodiment, to increase the capacitance and decrease impedance, there are three features taking place pin 1604, transition steps, and a dielectric jacket. Pin 1604 works by creating the time-varying E-field and the top adds capacitance set by its distance from the top of the waveguide. The dielectric jacket helps by adding capacitance and preventing the necessity of pin 1604 being too close to the top of the waveguide. The air pocket above and around pin 1604 serves the purpose of tuning the capacitance in a small, fine-tune way. The steps work by transitioning the coax impedance to the radial waveguide impedance.

In one embodiment, the steps allow for gradual radial waveguide height transition to the desired radial waveguide height—this height (and length) determines the radial waveguide characteristic impedance which is <<coax impedance. In other words, in one embodiment, the first step sets the starting impedance for approximately 1 wavelength and the following steps act as a quarter-wave transition to the desired characteristic impedance (see the equation below)

The steps also offer higher bandwidth, such that the more steps the higher the bandwidth

Length of first transition step, L˜λ₀*\sqrt{μᵣ/εᵣ}

One could also add a radial stub (similar to FIG. 15 discussed before) to pin 1604 to create a better match (increase capacitance) and increase bandwidth.

With respect to the dielectric jacket, its purpose is to decrease the height of pin 1604 so it will not have to be so close to the top of radial waveguide 1601. Since the transition is going form a inductance (coax) to capacitance (parallel plate) there needs to be a high level of capacitance. One way of obtaining that is a large area with a low distance to the top of radial waveguide 1601, such as provided with the equation below:

$$Capacitance = {ɛ}_{0} * \frac{Area}{Distance}$$

A purpose behind the airgap on top is mechanical limitations in the construction of the rexolite and pin 1604. If there was no air, the rexolite is difficult to manufacture and build, and the pin length and accuracy would need to be <+/−0.5 mil.

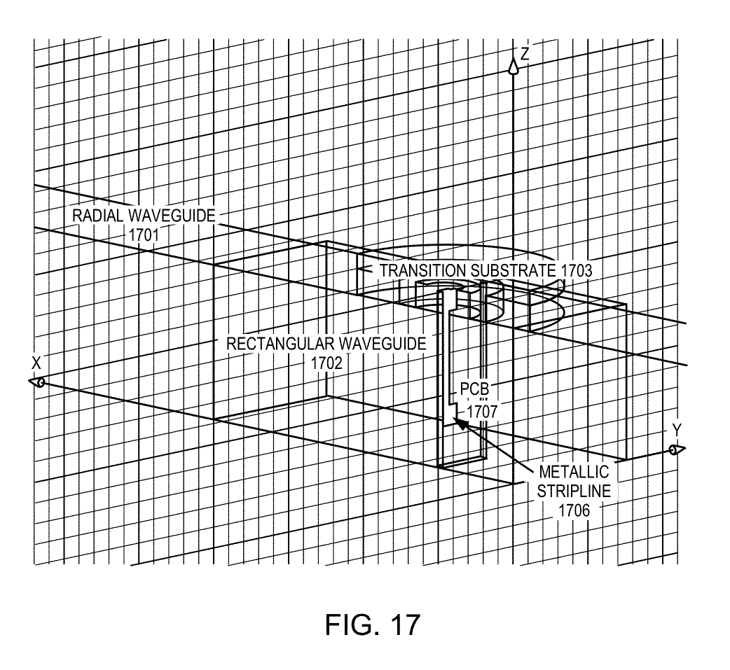

Note that the techniques described herein are not limited to coaxial transitions. Other transitions may be used, such as, for example, a stripline transition may be used. In such a case, the rectangular waveguide to coaxial transition and the coaxial to radial transition are replaced with a rectangular waveguide to stripline transition and a stripline to radial transition, respectively. FIG. 17 illustrates one embodiment of an RF launch with a stripline transition. Referring to FIG. 17, a metallic stripline on a printed circuit board (PCB) transitions RF energy from a rectangular waveguide to a radial waveguide via a transition substrate.

In the description that follows, a number of example antenna embodiments are disclosed that could use any of the RF launch embodiments described above to transfer RF energy. However, even though the focus in the description is on such antenna embodiments, it should be known that that the waveguide to radial mode transitions described above may be used in other RF components such as, for example, but not limited to, splitters, diplexers, etc.

### Examples of Antenna Systems

In one embodiment, the flat panel antenna with the RF launch described above is part of a metamaterial antenna system. Embodiments of a metamaterial antenna system for communications satellite earth stations are described. In one embodiment, the antenna system is a component or subsystem of a satellite earth station (ES) operating on a mobile platform (e.g., aeronautical, maritime, land, etc.) that operates using either Ka-band frequencies or Ku-band frequencies for civil commercial satellite communications. Note that embodiments of the antenna system also can be used in earth stations that are not on mobile platforms (e.g., fixed or transportable earth stations).

In one embodiment, the antenna system uses surface scattering metamaterial technology to form and steer transmit and receive beams through separate antennas. In one embodiment, the antenna systems are analog systems, in contrast to antenna systems that employ digital signal processing to electrically form and steer beams (such as phased array antennas).

In one embodiment, the antenna system is comprised of three functional subsystems: (1) a wave guiding structure consisting of a cylindrical wave feed architecture; (2) an array of wave scattering metamaterial unit cells that are part of antenna elements; and (3) a control structure to command formation of an adjustable radiation field (beam) from the metamaterial scattering elements using holographic principles.

### Antenna Elements

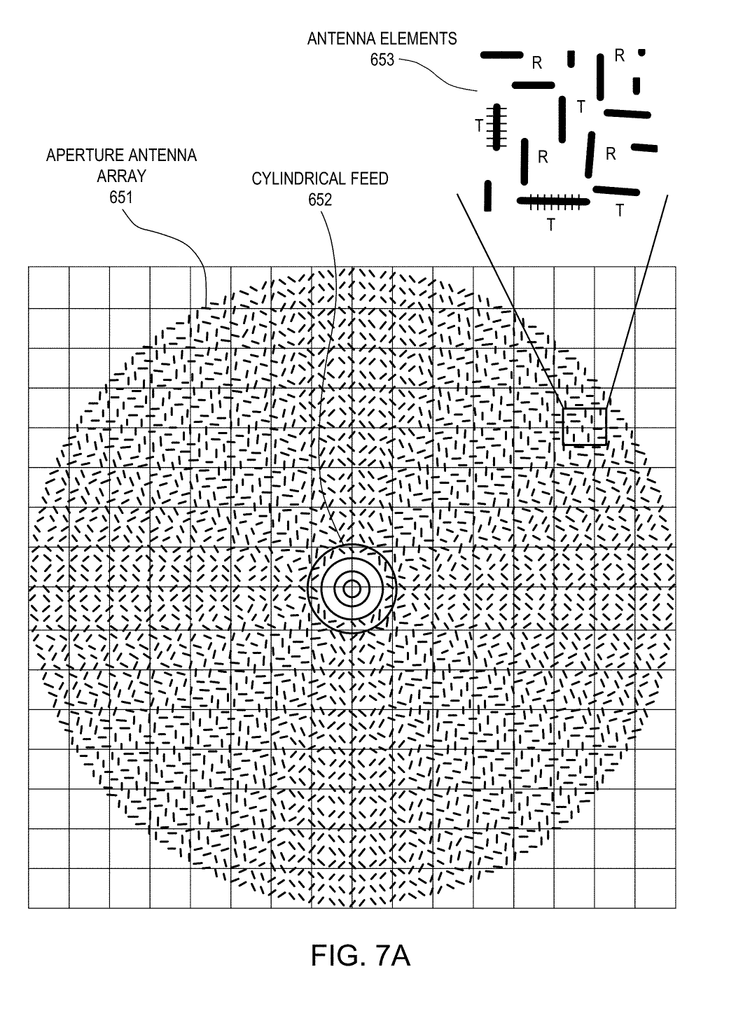

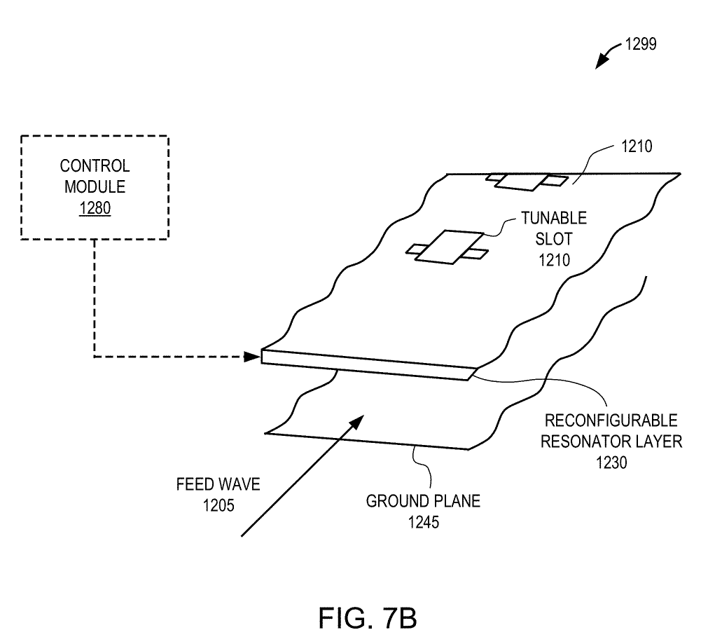

FIG. 7A illustrates the schematic of one embodiment of a cylindrically fed holographic radial aperture antenna. Referring to FIG. 7A, the antenna aperture has one or more arrays 651 of antenna elements 653 that are placed in concentric rings around an input feed 652 of the cylindrically fed antenna. In one embodiment, antenna elements 653 are radio frequency (RF) resonators that radiate RF energy. In one embodiment, antenna elements 653 comprise both Rx and Tx irises that are interleaved and distributed on the whole surface of the antenna aperture. Examples of such antenna elements are described in greater detail below. Note that the RF resonators described herein may be used in antennas that do not include a cylindrical feed.

In one embodiment, the antenna includes a coaxial feed that is used to provide a cylindrical wave feed via input feed 652. In one embodiment, the cylindrical wave feed architecture feeds the antenna from a central point with an excitation that spreads outward in a cylindrical manner from the feed point. That is, a cylindrically fed antenna creates an outward travelling concentric feed wave. Even so, the shape of the cylindrical feed antenna around the cylindrical feed can be circular, square or any shape. In another embodiment, a cylindrically fed antenna creates an inward travelling feed wave. In such a case, the feed wave most naturally comes from a circular structure.

In one embodiment, antenna elements 653 comprise irises and the aperture antenna of FIG. 7A is used to generate a main beam shaped by using excitation from a cylindrical feed wave for radiating irises through tunable liquid crystal (LC) material. In one embodiment, the antenna can be excited to radiate a horizontally or vertically polarized electric field at desired scan angles.

In one embodiment, the antenna elements comprise a group of patch antennas. This group of patch antennas comprises an array of scattering metamaterial elements. In one embodiment, each scattering element in the antenna system is part of a unit cell that consists of a lower conductor, a dielectric substrate and an upper conductor that embeds a complementary electric inductive-capacitive resonator (“complementary electric LC” or “CELC”) that is etched in or deposited onto the upper conductor. As would be understood by those skilled in the art, LC in the context of CELC refers to inductance-capacitance, as opposed to liquid crystal.

In one embodiment, a liquid crystal (LC) is disposed in the gap around the scattering element. This LC is driven by the direct drive embodiments described above. In one embodiment, liquid crystal is encapsulated in each unit cell and separates the lower conductor associated with a slot from an upper conductor associated with its patch. Liquid crystal has a permittivity that is a function of the orientation of the molecules comprising the liquid crystal, and the orientation of the molecules (and thus the permittivity) can be controlled by adjusting the bias voltage across the liquid crystal. Using this property, in one embodiment, the liquid crystal integrates an on/off switch for the transmission of energy from the guided wave to the CELC. When switched on, the CELC emits an electromagnetic wave like an electrically small dipole antenna. Note that the teachings herein are not limited to having a liquid crystal that operates in a binary fashion with respect to energy transmission.

In one embodiment, the feed geometry of this antenna system allows the antenna elements to be positioned at forty-five degree (45°) angles to the vector of the wave in the wave feed. Note that other positions may be used (e.g., at 40° angles). This position of the elements enables control of the free space wave received by or transmitted/radiated from the elements. In one embodiment, the antenna elements are arranged with an inter-element spacing that is less than a free-space wavelength of the operating frequency of the antenna. For example, if there are four scattering elements per wavelength, the elements in the 30 GHz transmit antenna will be approximately 2.5 mm (i.e., ¼th the 10 mm free-space wavelength of 30 GHz).

In one embodiment, the two sets of elements are perpendicular to each other and simultaneously have equal amplitude excitation if controlled to the same tuning state. Rotating them +/−45 degrees relative to the feed wave excitation achieves both desired features at once. Rotating one set 0 degrees and the other 90 degrees would achieve the perpendicular goal, but not the equal amplitude excitation goal. Note that 0 and 90 degrees may be used to achieve isolation when feeding the array of antenna elements in a single structure from two sides.

The amount of radiated power from each unit cell is controlled by applying a voltage to the patch (potential across the LC channel) using a controller. Traces to each patch are used to provide the voltage to the patch antenna. The voltage is used to tune or detune the capacitance and thus the resonance frequency of individual elements to effectuate beam forming. The voltage required is dependent on the liquid crystal mixture being used. The voltage tuning characteristic of liquid crystal mixtures is mainly described by a threshold voltage at which the liquid crystal starts to be affected by the voltage and the saturation voltage, above which an increase of the voltage does not cause major tuning in liquid crystal. These two characteristic parameters can change for different liquid crystal mixtures.

In one embodiment, as discussed above, a matrix drive is used to apply voltage to the patches in order to drive each cell separately from all the other cells without having a separate connection for each cell (direct drive). Because of the high density of elements, the matrix drive is an efficient way to address each cell individually.

In one embodiment, the control structure for the antenna system has 2 main components: the antenna array controller, which includes drive electronics, for the antenna system, is below the wave scattering structure, while the matrix drive switching array is interspersed throughout the radiating RF array in such a way as to not interfere with the radiation. In one embodiment, the drive electronics for the antenna system comprise commercial off-the shelf LCD controls used in commercial television appliances that adjust the bias voltage for each scattering element by adjusting the amplitude or duty cycle of an AC bias signal to that element.

In one embodiment, the antenna array controller also contains a microprocessor executing the software. The control structure may also incorporate sensors (e.g., a GPS receiver, a three-axis compass, a 3-axis accelerometer, 3-axis gyro, 3-axis magnetometer, etc.) to provide location and orientation information to the processor. The location and orientation information may be provided to the processor by other systems in the earth station and/or may not be part of the antenna system.

More specifically, the antenna array controller controls which elements are turned off and those elements turned on and at which phase and amplitude level at the frequency of operation. The elements are selectively detuned for frequency operation by voltage application.

For transmission, a controller supplies an array of voltage signals to the RF patches to create a modulation, or control pattern. The control pattern causes the elements to be turned to different states. In one embodiment, multistate control is used in which various elements are turned on and off to varying levels, further approximating a sinusoidal control pattern, as opposed to a square wave (i.e., a sinusoid gray shade modulation pattern). In one embodiment, some elements radiate more strongly than others, rather than some elements radiate and some do not. Variable radiation is achieved by applying specific voltage levels, which adjusts the liquid crystal permittivity to varying amounts, thereby detuning elements variably and causing some elements to radiate more than others.

The generation of a focused beam by the metamaterial array of elements can be explained by the phenomenon of constructive and destructive interference. Individual electromagnetic waves sum up (constructive interference) if they have the same phase when they meet in free space and waves cancel each other (destructive interference) if they are in opposite phase when they meet in free space. If the slots in a slotted antenna are positioned so that each successive slot is positioned at a different distance from the excitation point of the guided wave, the scattered wave from that element will have a different phase than the scattered wave of the previous slot. If the slots are spaced one quarter of a guided wavelength apart, each slot will scatter a wave with a one fourth phase delay from the previous slot.

Using the array, the number of patterns of constructive and destructive interference that can be produced can be increased so that beams can be pointed theoretically in any direction plus or minus ninety degrees (90°) from the bore sight of the antenna array, using the principles of holography. Thus, by controlling which metamaterial unit cells are turned on or off (i.e., by changing the pattern of which cells are turned on and which cells are turned off), a different pattern of constructive and destructive interference can be produced, and the antenna can change the direction of the main beam. The time required to turn the unit cells on and off dictates the speed at which the beam can be switched from one location to another location.

In one embodiment, the antenna system produces one steerable beam for the uplink antenna and one steerable beam for the downlink antenna. In one embodiment, the antenna system uses metamaterial technology to receive beams and to decode signals from the satellite and to form transmit beams that are directed toward the satellite. In one embodiment, the antenna systems are analog systems, in contrast to antenna systems that employ digital signal processing to electrically form and steer beams (such as phased array antennas). In one embodiment, the antenna system is considered a “surface” antenna that is planar and relatively low profile, especially when compared to conventional satellite dish receivers.

FIG. 7B illustrates a perspective view of one row of antenna elements that includes a ground plane and a reconfigurable resonator layer. Reconfigurable resonator layer 1230 includes an array of tunable slots 1210. The array of tunable slots 1210 can be configured to point the antenna in a desired direction. Each of the tunable slots can be tuned/adjusted by varying a voltage across the liquid crystal.

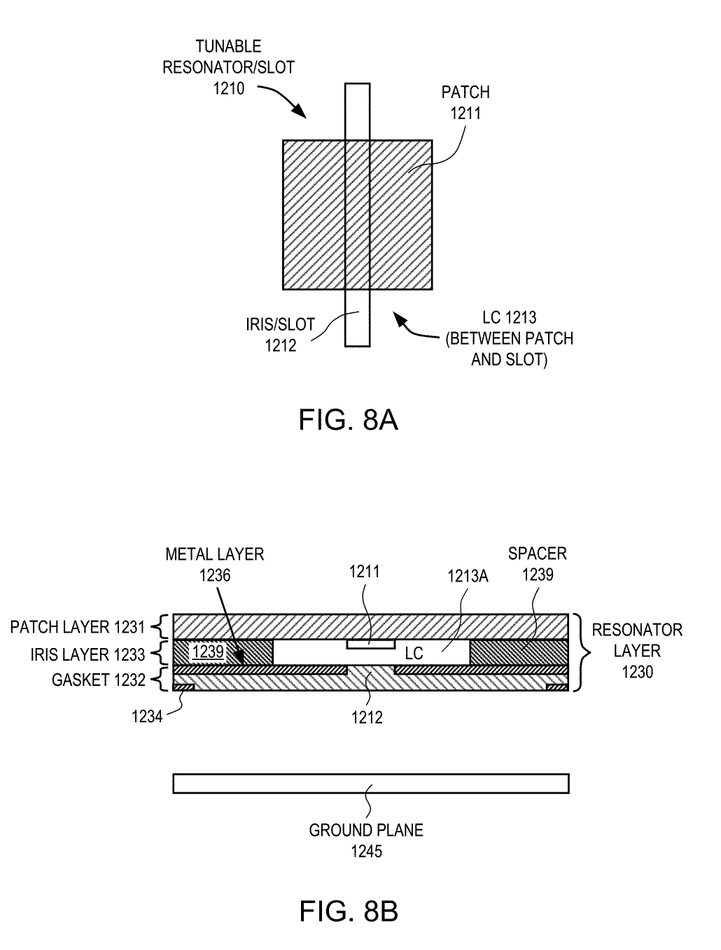

Control module 1280 is coupled to reconfigurable resonator layer 1230 to modulate the array of tunable slots 1210 by varying the voltage across the liquid crystal in FIG. 8A. Control module 1280 may include a Field Programmable Gate Array (“FPGA”), a microprocessor, a controller, System-on-a-Chip (SoC), or other processing logic. In one embodiment, control module 1280 includes logic circuitry (e.g., multiplexer) to drive the array of tunable slots 1210. In one embodiment, control module 1280 receives data that includes specifications for a holographic diffraction pattern to be driven onto the array of tunable slots 1210. The holographic diffraction patterns may be generated in response to a spatial relationship between the antenna and a satellite so that the holographic diffraction pattern steers the downlink beams (and uplink beam if the antenna system performs transmit) in the appropriate direction for communication. Although not drawn in each figure, a control module similar to control module 1280 may drive each array of tunable slots described in the figures of the disclosure.

Radio Frequency (“RF”) holography is also possible using analogous techniques where a desired RF beam can be generated when an RF reference beam encounters an RF holographic diffraction pattern. In the case of satellite communications, the reference beam is in the form of a feed wave, such as feed wave 1205 (approximately 20 GHz in some embodiments). To transform a feed wave into a radiated beam (either for transmitting or receiving purposes), an interference pattern is calculated between the desired RF beam (the object beam) and the feed wave (the reference beam). The interference pattern is driven onto the array of tunable slots 1210 as a diffraction pattern so that the feed wave is “steered” into the desired RF beam (having the desired shape and direction). In other words, the feed wave encountering the holographic diffraction pattern “reconstructs” the object beam, which is formed according to design requirements of the communication system. The holographic diffraction pattern contains the excitation of each element and is calculated by w_{hologram}=w*ᵢₙwₒᵤₜ, with wᵢₙ as the wave equation in the waveguide and wₒᵤₜ the wave equation on the outgoing wave.

FIG. 8A illustrates one embodiment of a tunable resonator/slot 1210. Tunable slot 1210 includes an iris/slot 1212, a radiating patch 1211, and liquid crystal 1213 disposed between iris 1212 and patch 1211. In one embodiment, radiating patch 1211 is co-located with iris 1212.

FIG. 8B illustrates a cross section view of one embodiment of a physical antenna aperture. The antenna aperture includes ground plane 1245, and a metal layer 1236 within iris layer 1233, which is included in reconfigurable resonator layer 1230. In one embodiment, the antenna aperture of FIG. 8B includes a plurality of tunable resonator/slots 1210 of FIG. 8A. Iris/slot 1212 is defined by openings in metal layer 1236. A feed wave, such as feed wave 1205 of FIG. 8A, may have a microwave frequency compatible with satellite communication channels. The feed wave propagates between ground plane 1245 and resonator layer 1230.

Reconfigurable resonator layer 1230 also includes gasket layer 1232 and patch layer 1231. Gasket layer 1232 is disposed between patch layer 1231 and iris layer 1233. Note that in one embodiment, a spacer could replace gasket layer 1232. In one embodiment, iris layer 1233 is a printed circuit board (“PCB”) that includes a copper layer as metal layer 1236. In one embodiment, iris layer 1233 is glass. Iris layer 1233 may be other types of substrates.

Openings may be etched in the copper layer to form slots 1212. In one embodiment, iris layer 1233 is conductively coupled by a conductive bonding layer to another structure (e.g., a waveguide) in FIG. 8B. Note that in an embodiment the iris layer is not conductively coupled by a conductive bonding layer and is instead interfaced with a non-conducting bonding layer.

Patch layer 1231 may also be a PCB that includes metal as radiating patches 1211. In one embodiment, gasket layer 1232 includes spacers 1239 that provide a mechanical standoff to define the dimension between metal layer 1236 and patch 1211. In one embodiment, the spacers are 75 microns, but other sizes may be used (e.g., 3-200 mm). As mentioned above, in one embodiment, the antenna aperture of FIG. 8B includes multiple tunable resonator/slots, such as tunable resonator/slot 1210 includes patch 1211, liquid crystal 1213, and iris 1212 of FIG. 8A. The chamber for liquid crystal 1213 is defined by spacers 1239, iris layer 1233 and metal layer 1236. When the chamber is filled with liquid crystal, patch layer 1231 can be laminated onto spacers 1239 to seal liquid crystal within resonator layer 1230.

A voltage between patch layer 1231 and iris layer 1233 can be modulated to tune the liquid crystal in the gap between the patch and the slots (e.g., tunable resonator/slot 1210). Adjusting the voltage across liquid crystal 1213 varies the capacitance of a slot (e.g., tunable resonator/slot 1210). Accordingly, the reactance of a slot (e.g., tunable resonator/slot 1210) can be varied by changing the capacitance. The resonant frequency of slot 1210 also changes according to the equation

$$f = \frac{1}{2 π \sqrt[ ]{LC}} ,$$

where f is the resonant frequency of slot 1210 and L and C are the inductance and capacitance of slot 1210, respectively. The resonant frequency of slot 1210 affects the energy radiated from feed wave 1205 propagating through the waveguide. As an example, if feed wave 1205 is 20 GHz, the resonant frequency of a slot 1210 may be adjusted (by varying the capacitance) to 17 GHz so that the slot 1210 couples substantially no energy from feed wave 1205. Or, the resonant frequency of a slot 1210 may be adjusted to 20 GHz so that the slot 1210 couples energy from feed wave 1205 and radiates that energy into free space. Although the examples given are binary (fully radiating or not radiating at all), full gray scale control of the reactance, and therefore the resonant frequency of slot 1210 is possible with voltage variance over a multi-valued range. Hence, the energy radiated from each slot 1210 can be finely controlled so that detailed holographic diffraction patterns can be formed by the array of tunable slots.

In one embodiment, tunable slots in a row are spaced from each other by λ/5. Other spacings may be used. In one embodiment, each tunable slot in a row is spaced from the closest tunable slot in an adjacent row by λ/2, and, thus, commonly oriented tunable slots in different rows are spaced by λ/4, though other spacings are possible (e.g., λ/5, λ/6.3). In another embodiment, each tunable slot in a row is spaced from the closest tunable slot in an adjacent row by λ/3.

Embodiments use reconfigurable metamaterial technology, such as described in U.S. patent application Ser. No. 14/550,178, entitled “Dynamic Polarization and Coupling Control from a Steerable Cylindrically Fed Holographic Antenna”, filed Nov. 21, 2014 and U.S. patent application Ser. No. 14/610,502, entitled “Ridged Waveguide Feed Structures for Reconfigurable Antenna”, filed Jan. 30, 2015.

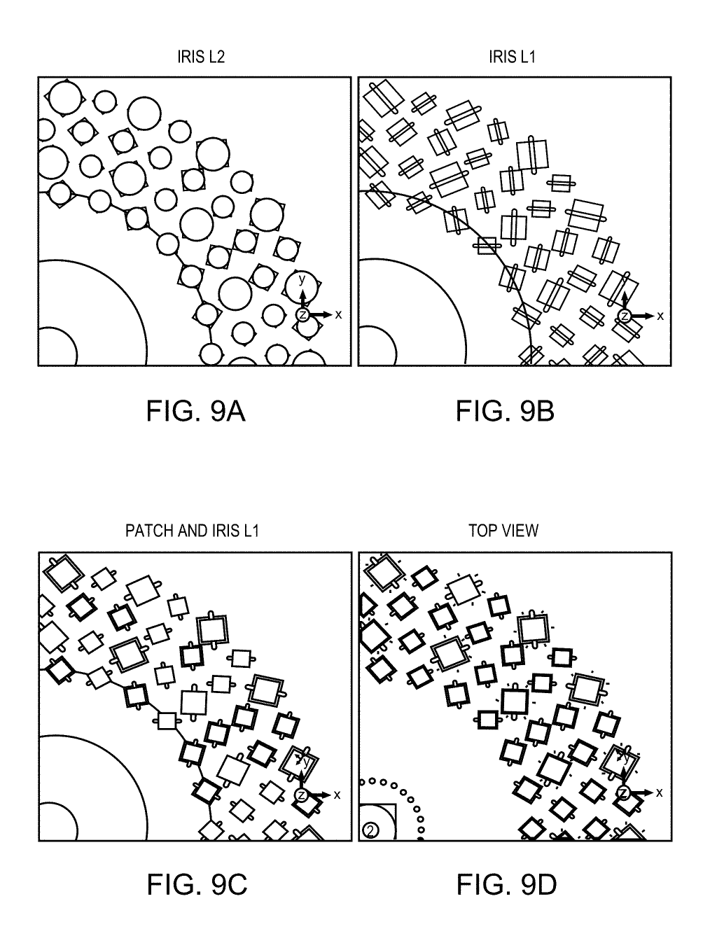

FIGS. 9A-D illustrate one embodiment of the different layers for creating the slotted array. The antenna array includes antenna elements that are positioned in rings, such as the example rings shown in FIG. 7A. Note that in this example the antenna array has two different types of antenna elements that are used for two different types of frequency bands.

FIG. 9A illustrates a portion of the first iris board layer with locations corresponding to the slots. Referring to FIG. 9A, the circles are open areas/slots in the metallization in the bottom side of the iris substrate, and are for controlling the coupling of elements to the feed (the feed wave). Note that this layer is an optional layer and is not used in all designs. FIG. 9B illustrates a portion of the second iris board layer containing slots. FIG. 9C illustrates patches over a portion of the second iris board layer. FIG. 9D illustrates a top view of a portion of the slotted array.

FIG. 10 illustrates a side view of one embodiment of a cylindrically fed antenna structure. The antenna produces an inwardly travelling wave using a double layer feed structure (i.e., two layers of a feed structure). In one embodiment, the antenna includes a circular outer shape, though this is not required. That is, non-circular inward travelling structures can be used. In one embodiment, the antenna structure in FIG. 10 includes a coaxial feed, such as, for example, described in U.S. Publication No. 2015/0236412, entitled “Dynamic Polarization and Coupling Control from a Steerable Cylindrically Fed Holographic Antenna”, filed on Nov. 21, 2014.

Referring to FIG. 10, a coaxial pin 1601 is used to excite the field on the lower level of the antenna. In one embodiment, coaxial pin 1601 is a 50Ω coaxial pin that is readily available. Coaxial pin 1601 is coupled (e.g., bolted) to the bottom of the antenna structure, which is conducting ground plane 1602.

Separate from conducting ground plane 1602 is interstitial conductor 1603, which is an internal conductor. In one embodiment, conducting ground plane 1602 and interstitial conductor 1603 are parallel to each other. In one embodiment, the distance between ground plane 1602 and interstitial conductor 1603 is 0.1-0.15″. In another embodiment, this distance may be λ/2, where λ is the wavelength of the travelling wave at the frequency of operation.

Ground plane 1602 is separated from interstitial conductor 1603 via a spacer 1604. In one embodiment, spacer 1604 is a foam or air-like spacer. In one embodiment, spacer 1604 comprises a plastic spacer.

On top of interstitial conductor 1603 is dielectric layer 1605. In one embodiment, dielectric layer 1605 is plastic. The purpose of dielectric layer 1605 is to slow the travelling wave relative to free space velocity. In one embodiment, dielectric layer 1605 slows the travelling wave by 30% relative to free space. In one embodiment, the range of indices of refraction that are suitable for beam forming are 1.2-1.8, where free space has by definition an index of refraction equal to 1. Other dielectric spacer materials, such as, for example, plastic, may be used to achieve this effect. Note that materials other than plastic may be used as long as they achieve the desired wave slowing effect. Alternatively, a material with distributed structures may be used as dielectric 1605, such as periodic sub-wavelength metallic structures that can be machined or lithographically defined, for example.

An RF-array 1606 is on top of dielectric 1605. In one embodiment, the distance between interstitial conductor 1603 and RF-array 1606 is 0.1-0.15″. In another embodiment, this distance may be λ_{eff}/2, where λ_{eff} is the effective wavelength in the medium at the design frequency.

The antenna includes sides 1607 and 1608. Sides 1607 and 1608 are angled to cause a travelling wave feed from coaxial pin 1601 to be propagated from the area below interstitial conductor 1603 (the spacer layer) to the area above interstitial conductor 1603 (the dielectric layer) via reflection. In one embodiment, the angle of sides 1607 and 1608 are at 45° angles. In an alternative embodiment, sides 1607 and 1608 could be replaced with a continuous radius to achieve the reflection. While FIG. 10 shows angled sides that have angle of 45 degrees, other angles that accomplish signal transmission from lower level feed to upper level feed may be used. That is, given that the effective wavelength in the lower feed will generally be different than in the upper feed, some deviation from the ideal 45° angles could be used to aid transmission from the lower to the upper feed level. For example, in another embodiment, the 45° angles are replaced with a single step. The steps on one end of the antenna go around the dielectric layer, interstitial the conductor, and the spacer layer. The same two steps are at the other ends of these layers.

In operation, when a feed wave is fed in from coaxial pin 1601, the wave travels outward concentrically oriented from coaxial pin 1601 in the area between ground plane 1602 and interstitial conductor 1603. The concentrically outgoing waves are reflected by sides 1607 and 1608 and travel inwardly in the area between interstitial conductor 1603 and RF array 1606. The reflection from the edge of the circular perimeter causes the wave to remain in phase (i.e., it is an in-phase reflection). The travelling wave is slowed by dielectric layer 1605. At this point, the travelling wave starts interacting and exciting with elements in RF array 1606 to obtain the desired scattering.

To terminate the travelling wave, a termination 1609 is included in the antenna at the geometric center of the antenna. In one embodiment, termination 1609 comprises a pin termination (e.g., a 50Ω pin). In another embodiment, termination 1609 comprises an RF absorber that terminates unused energy to prevent reflections of that unused energy back through the feed structure of the antenna. These could be used at the top of RF array 1606.

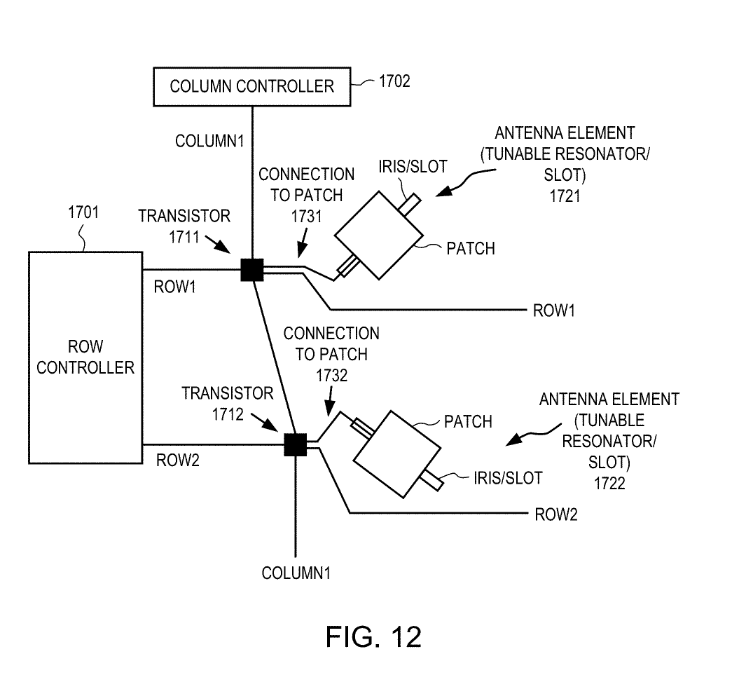

FIG. 11 illustrates another embodiment of the antenna system with an outgoing wave. Referring to FIG. 11, two ground planes 1610 and 1611 are substantially parallel to each other with a dielectric layer 1612 (e.g., a plastic layer, etc.) in between ground planes. RF absorbers 1619 (e.g., resistors) couple the two ground planes 1610 and 1611 together. A coaxial pin 1615 (e.g., 50Ω) feeds the antenna. An RF array 1616 is on top of dielectric layer 1612 and ground plane 1611.

In operation, a feed wave is fed through coaxial pin 1615 and travels concentrically outward and interacts with the elements of RF array 1616.

The cylindrical feed in both the antennas of FIGS. 10 and 11 improves the service angle of the antenna. Instead of a service angle of plus or minus forty-five degrees azimuth (±45° Az) and plus or minus twenty-five degrees elevation (±25° El), in one embodiment, the antenna system has a service angle of seventy-five degrees (75°) from the bore sight in all directions. As with any beam forming antenna comprised of many individual radiators, the overall antenna gain is dependent on the gain of the constituent elements, which themselves are angle-dependent. When using common radiating elements, the overall antenna gain typically decreases as the beam is pointed further off bore sight. At 75 degrees off bore sight, significant gain degradation of about 6 dB is expected.

Embodiments of the antenna having a cylindrical feed solve one or more problems. These include dramatically simplifying the feed structure compared to antennas fed with a corporate divider network and therefore reducing total required antenna and antenna feed volume; decreasing sensitivity to manufacturing and control errors by maintaining high beam performance with coarser controls (extending all the way to simple binary control); giving a more advantageous side lobe pattern compared to rectilinear feeds because the cylindrically oriented feed waves result in spatially diverse side lobes in the far field; and allowing polarization to be dynamic, including allowing left-hand circular, right-hand circular, and linear polarizations, while not requiring a polarizer.

### Array of Wave Scattering Elements

RF array 1606 of FIG. 10 and RF array 1616 of FIG. 11 include a wave scattering subsystem that includes a group of patch antennas (i.e., scatterers) that act as radiators. This group of patch antennas comprises an array of scattering metamaterial elements.

In one embodiment, each scattering element in the antenna system is part of a unit cell that consists of a lower conductor, a dielectric substrate and an upper conductor that embeds a complementary electric inductive-capacitive resonator (“complementary electric LC” or “CELC”) that is etched in or deposited onto the upper conductor.

In one embodiment, a liquid crystal (LC) is injected in the gap around the scattering element. Liquid crystal is encapsulated in each unit cell and separates the lower conductor associated with a slot from an upper conductor associated with its patch. Liquid crystal has a permittivity that is a function of the orientation of the molecules comprising the liquid crystal, and the orientation of the molecules (and thus the permittivity) can be controlled by adjusting the bias voltage across the liquid crystal. Using this property, the liquid crystal acts as an on/off switch for the transmission of energy from the guided wave to the CELC. When switched on, the CELC emits an electromagnetic wave like an electrically small dipole antenna.

Controlling the thickness of the LC increases the beam switching speed. A fifty percent (50%) reduction in the gap between the lower and the upper conductor (the thickness of the liquid crystal) results in a fourfold increase in speed. In another embodiment, the thickness of the liquid crystal results in a beam switching speed of approximately fourteen milliseconds (14 ms). In one embodiment, the LC is doped in a manner well-known in the art to improve responsiveness so that a seven millisecond (7 ms) requirement can be met.

The CELC element is responsive to a magnetic field that is applied parallel to the plane of the CELC element and perpendicular to the CELC gap complement. When a voltage is applied to the liquid crystal in the metamaterial scattering unit cell, the magnetic field component of the guided wave induces a magnetic excitation of the CELC, which, in turn, produces an electromagnetic wave in the same frequency as the guided wave.

The phase of the electromagnetic wave generated by a single CELC can be selected by the position of the CELC on the vector of the guided wave. Each cell generates a wave in phase with the guided wave parallel to the CELC. Because the CELCs are smaller than the wave length, the output wave has the same phase as the phase of the guided wave as it passes beneath the CELC.

In one embodiment, the cylindrical feed geometry of this antenna system allows the CELC elements to be positioned at forty-five degree (45°) angles to the vector of the wave in the wave feed. This position of the elements enables control of the polarization of the free space wave generated from or received by the elements. In one embodiment, the CELCs are arranged with an inter-element spacing that is less than a free-space wavelength of the operating frequency of the antenna. For example, if there are four scattering elements per wavelength, the elements in the 30 GHz transmit antenna will be approximately 2.5 mm (i.e., ¼th the 10 mm free-space wavelength of 30 GHz).

In one embodiment, the CELCs are implemented with patch antennas that include a patch co-located over a slot with liquid crystal between the two. In this respect, the metamaterial antenna acts like a slotted (scattering) wave guide. With a slotted wave guide, the phase of the output wave depends on the location of the slot in relation to the guided wave.

### Cell Placement

In one embodiment, the antenna elements are placed on the cylindrical feed antenna aperture in a way that allows for a systematic matrix drive circuit. The placement of the cells includes placement of the transistors for the matrix drive. FIG. 12 illustrates one embodiment of the placement of matrix drive circuitry with respect to antenna elements. Referring to FIG. 12, row controller 1701 is coupled to transistors 1711 and 1712, via row select signals Row1 and Row2, respectively, and column controller 1702 is coupled to transistors 1711 and 1712 via column select signal Column1. Transistor 1711 is also coupled to antenna element 1721 via connection to patch 1731, while transistor 1712 is coupled to antenna element 1722 via connection to patch 1732.

In an initial approach to realize matrix drive circuitry on the cylindrical feed antenna with unit cells placed in a non-regular grid, two steps are performed. In the first step, the cells are placed on concentric rings and each of the cells is connected to a transistor that is placed beside the cell and acts as a switch to drive each cell separately. In the second step, the matrix drive circuitry is built in order to connect every transistor with a unique address as the matrix drive approach requires. Because the matrix drive circuit is built by row and column traces (similar to LCDs) but the cells are placed on rings, there is no systematic way to assign a unique address to each transistor. This mapping problem results in very complex circuitry to cover all the transistors and leads to a significant increase in the number of physical traces to accomplish the routing. Because of the high density of cells, those traces disturb the RF performance of the antenna due to coupling effect. Also, due to the complexity of traces and high packing density, the routing of the traces cannot be accomplished by commercially available layout tools.

In one embodiment, the matrix drive circuitry is predefined before the cells and transistors are placed. This ensures a minimum number of traces that are necessary to drive all the cells, each with a unique address. This strategy reduces the complexity of the drive circuitry and simplifies the routing, which subsequently improves the RF performance of the antenna.

More specifically, in one approach, in the first step, the cells are placed on a regular rectangular grid composed of rows and columns that describe the unique address of each cell. In the second step, the cells are grouped and transformed to concentric circles while maintaining their address and connection to the rows and columns as defined in the first step. A goal of this transformation is not only to put the cells on rings but also to keep the distance between cells and the distance between rings constant over the entire aperture. In order to accomplish this goal, there are several ways to group the cells.

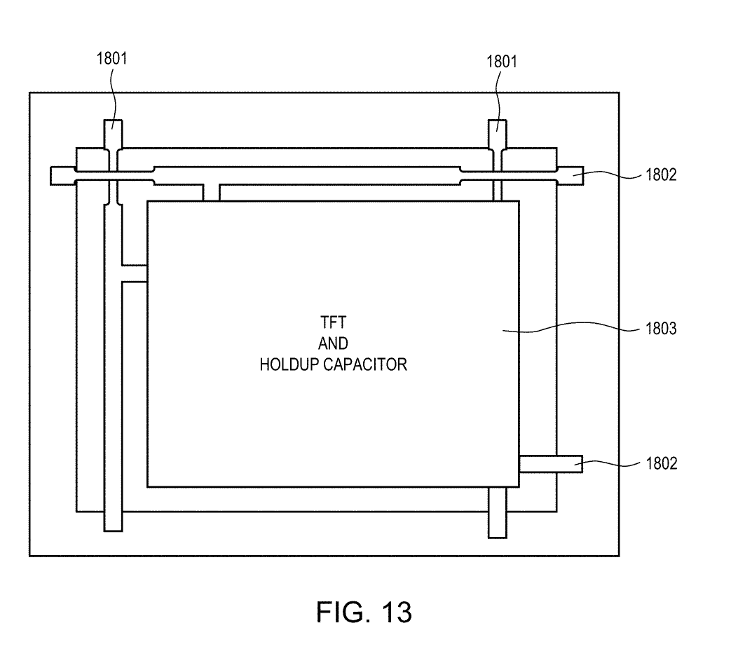

In one embodiment, a TFT package is used to enable placement and unique addressing in the matrix drive. FIG. 13 illustrates one embodiment of a TFT package. Referring to FIG. 13, a TFT and a hold capacitor 1803 is shown with input and output ports. There are two input ports connected to traces 1801 and two output ports connected to traces 1802 to connect the TFTs together using the rows and columns. In one embodiment, the row and column traces cross in 90° angles to reduce, and potentially minimize, the coupling between the row and column traces. In one embodiment, the row and column traces are on different layers.

### An Example of a Full Duplex Communication System

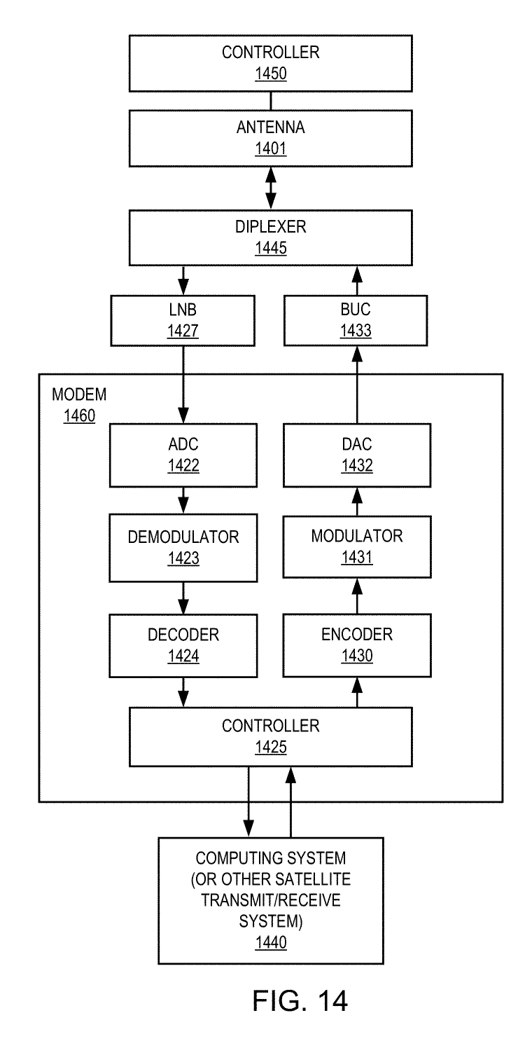

In another embodiment, the combined antenna apertures are used in a full duplex communication system. FIG. 14 is a block diagram of another embodiment of a communication system having simultaneous transmit and receive paths. While only one transmit path and one receive path are shown, the communication system may include more than one transmit path and/or more than one receive path.

Referring to FIG. 14, antenna 1401 includes two spatially interleaved antenna arrays operable independently to transmit and receive simultaneously at different frequencies as described above. In one embodiment, antenna 1401 is coupled to diplexer 1445. The coupling may be by one or more feeding networks. In one embodiment, in the case of a radial feed antenna, diplexer 1445 combines the two signals and the connection between antenna 1401 and diplexer 1445 is a single broad-band feeding network that can carry both frequencies.

Diplexer 1445 is coupled to a low noise block down converter (LNB) 1427, which performs a noise filtering function and a down conversion and amplification function in a manner well-known in the art. In one embodiment, LNB 1427 is in an out-door unit (ODU). In another embodiment, LNB 1427 is integrated into the antenna apparatus. LNB 1427 is coupled to a modem 1460, which is coupled to computing system 1440 (e.g., a computer system, modem, etc.).

Modem 1460 includes an analog-to-digital converter (ADC) 1422, which is coupled to LNB 1427, to convert the received signal output from diplexer 1445 into digital format. Once converted to digital format, the signal is demodulated by demodulator 1423 and decoded by decoder 1424 to obtain the encoded data on the received wave. The decoded data is then sent to controller 1425, which sends it to computing system 1440.

Modem 1460 also includes an encoder 1430 that encodes data to be transmitted from computing system 1440. The encoded data is modulated by modulator 1431 and then converted to analog by digital-to-analog converter (DAC) 1432. The analog signal is then filtered by a BUC (up-convert and high pass amplifier) 1433 and provided to one port of diplexer 1445. In one embodiment, BUC 1433 is in an out-door unit (ODU).

Diplexer 1445 operating in a manner well-known in the art provides the transmit signal to antenna 1401 for transmission.

Controller 1450 controls antenna 1401, including the two arrays of antenna elements on the single combined physical aperture.

The communication system would be modified to include the combiner/arbiter described above. In such a case, the combiner/arbiter after the modem but before the BUC and LNB.

Note that the full duplex communication system shown in FIG. 14 has a number of applications, including but not limited to, internet communication, vehicle communication (including software updating), etc.

There is a number of example embodiments described herein.

Example 1 is an apparatus comprising: a radial waveguide having at least one plate; a radio-frequency (RF) launch coupled to the radial waveguide comprising a rectangular waveguide, a rectangular waveguide to coaxial transition coupled to the rectangular waveguide, and a coaxial to radial transition coupled to the rectangular waveguide to coaxial transition.

Example 2 is the apparatus of example 1 that may optionally include that the rectangular waveguide has a radial non-symmetric mode and the coaxial to radial transition has a radial symmetric mode.

Example 3 is the apparatus of example 1 that may optionally include that the rectangular waveguide to coaxial transition is coupled to the rectangular waveguide at a 90° angle.

Example 4 is the apparatus of example 1 that may optionally include that the coaxial to radial transition has a coaxial transmission line with a dielectric constant that is higher than air.

Example 5 is the apparatus of example 4 that may optionally include that the coax is configured to maintain a pin of the coaxial to radial transition in a centered position with respect to the coaxial to radial transition.

Example 6 is the apparatus of example 1 that may optionally include that the rectangular waveguide to coaxial transition is coupled to the coaxial to radial transition via a pin.

Example 7 is the apparatus of example 6 that may optionally include that the coaxial to radial transition has a pin and the pin is fit in a pin receptacle of the rectangular waveguide to coaxial transition.

Example 8 is the apparatus of example 6 that may optionally include that the pin is a press fit pin.

Example 9 is the apparatus of example 6 that may optionally include that the rectangular waveguide to coaxial transition comprises brass, copper, or aluminum and has a pin receptacle comprising copper, aluminum, or magnesium.

Example 10 is the apparatus of example 1 that may optionally include that the coaxial to radial transition comprises an interface shaped into concentric tiers.

Example 11 is the apparatus of example 1 that may optionally include that the radial waveguide comprises a parallel plate waveguide.

Example 12 is the apparatus of example 1 that may optionally include that the RF launch is operable to input a feed wave that propagates concentrically from the RF launch.

Example 13 is an apparatus comprising: a radial waveguide having at least one plate; a radio-frequency (RF) launch coupled to the radial waveguide comprising a rectangular waveguide, a rectangular waveguide to stripline transition coupled to the rectangular waveguide, and a stripline to radial transition coupled to the rectangular waveguide to coaxial transition.

Example 14 is the apparatus of example 13 that may optionally include that the rectangular waveguide has a radial non-symmetric mode and the stripline to radial transition has a radial symmetric mode.

Example 15 is an antenna comprising: a radial parallel plate waveguide; a radio-frequency (RF) launch coupled to the radial parallel plate waveguide comprising a rectangular waveguide having a radial non-symmetric mode, a rectangular waveguide to coaxial stepped transition coupled to the rectangular waveguide, and a coaxial to radial transition coupled to the rectangular waveguide to coax stepped transition and having a radial symmetric mode.

Example 16 is the antenna of example 15 that may optionally include that the rectangular waveguide to coaxial stepped transition is coupled to the rectangular waveguide at a 90° angle.

Example 17 is the antenna of example 15 that may optionally include that the coaxial to radial transition has a coaxial transmission line insulator with a dielectric constant that is higher than air.

Example 18 is the antenna of example 17 that may optionally include that the coaxial transmission line is configured to maintain a pin of the coaxial to radial transition in a centered position with respect to the coaxial to radial transition.

Example 19 is the antenna of example 15 that may optionally include that the rectangular waveguide to coaxial stepped transition is coupled to the coaxial to radial transition via a pin.

Example 20 is the antenna of example 19 that may optionally include that the coaxial to radial transition has the pin and the pin is fit in a pin receptacle of the rectangular waveguide to coaxial stepped transition.

Example 21 is the antenna of example 20 that may optionally include that the pin is a press fit pin.

Example 22 is the antenna of example 15 that may optionally include that the coaxial to radial transition comprises an interface shaped into concentric tiers.

Example 23 is an antenna comprising: a radial parallel plate waveguide; a radio-frequency (RF) launch coupled to the radial parallel plate waveguide comprising a rectangular waveguide having a radial non-symmetric mode, a rectangular waveguide to coaxial stepped transition coupled to the rectangular waveguide and having a pin receptacle, and a coaxial to radial transition coupled to the rectangular waveguide to coaxial stepped transition and having a radial symmetric mode, wherein the coaxial to radial transition has a pin that is coupled to the pin receptacle.

Example 24 is the antenna of example 23 that may optionally include that the coaxial to radial transition has a coaxial with a dielectric constant that is higher than air and is configured to maintain the pin of the coaxial to radial transition in a centered position with respect to the coaxial to radial transition.

Example 25 is the antenna of example 23 that may optionally include that the coaxial to radial transition comprises an interface shaped into concentric tiers.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. An apparatus comprising:
a radial waveguide having at least one plate;
a radio-frequency (RF) launch coupled to the radial waveguide comprising
a rectangular waveguide,
a rectangular waveguide to coaxial transition coupled to the rectangular waveguide, and
a coaxial to radial transition coupled to the rectangular waveguide to coaxial transition.

2. The apparatus defined in claim 1 wherein the rectangular waveguide has a radial non-symmetric mode and the coaxial to radial transition has a radial symmetric mode.

3. The apparatus defined in claim 1 wherein the rectangular waveguide to coaxial transition is coupled to the rectangular waveguide at a 90° angle.

4. The apparatus defined in claim 1 wherein the coaxial to radial transition has a coaxial transmission line with a dielectric constant that is higher than air.

5. The apparatus defined in claim 4 wherein the coax is configured to maintain a pin of the coaxial to radial transition in a centered position with respect to the coaxial to radial transition.

6. The apparatus defined in claim 1 wherein the rectangular waveguide to coaxial transition is coupled to the coaxial to radial transition via a pin.

7. The apparatus defined in claim 6 wherein the coaxial to radial transition has a pin and the pin is fit in a pin receptacle of the rectangular waveguide to coaxial transition.

8. The apparatus defined in claim 6 wherein the pin is a press fit pin.

9. The apparatus defined in claim 6 wherein the rectangular waveguide to coaxial transition comprises brass, copper, or aluminum and has a pin receptacle comprising copper, aluminum, or magnesium.

10. The apparatus defined in claim 1 wherein the coaxial to radial transition comprises an interface shaped into concentric tiers.

11. The apparatus defined in claim 1 wherein the radial waveguide comprises a parallel plate waveguide.

12. The apparatus defined in claim 1 wherein the RF launch is operable to input a feed wave that propagates concentrically from the RF launch.

13. An apparatus comprising:
a radial waveguide having at least one plate;
a radio-frequency (RF) launch coupled to the radial waveguide comprising
a rectangular waveguide,
a rectangular waveguide to stripline transition coupled to the rectangular waveguide, and
a stripline to radial transition coupled to the rectangular waveguide to coaxial transition.

14. The apparatus defined in claim 13 wherein the rectangular waveguide has a radial non-symmetric mode and the stripline to radial transition has a radial symmetric mode.

15. An antenna comprising:
a radial parallel plate waveguide;
a radio-frequency (RF) launch coupled to the radial parallel plate waveguide comprising
a rectangular waveguide having a radial non-symmetric mode,
a rectangular waveguide to coaxial stepped transition coupled to the rectangular waveguide, and
a coaxial to radial transition coupled to the rectangular waveguide to coax stepped transition and having a radial symmetric mode.

16. The antenna defined in claim 15 wherein the rectangular waveguide to coaxial stepped transition is coupled to the rectangular waveguide at a 90° angle.

17. The antenna defined in claim 15 wherein the coaxial to radial transition has a coaxial transmission line insulator with a dielectric constant that is higher than air.

18. The antenna defined in claim 17 wherein the coaxial transmission line is configured to maintain a pin of the coaxial to radial transition in a centered position with respect to the coaxial to radial transition.

19. The antenna defined in claim 15 wherein the rectangular waveguide to coaxial stepped transition is coupled to the coaxial to radial transition via a pin.

20. The antenna defined in claim 19 wherein the coaxial to radial transition has the pin and the pin is fit in a pin receptacle of the rectangular waveguide to coaxial stepped transition.

21. The antenna defined in claim 20 wherein the pin is a press fit pin.

22. The antenna defined in claim 15 wherein the coaxial to radial transition comprises an interface shaped into concentric tiers.

23. An antenna comprising:
a radial parallel plate waveguide;
a radio-frequency (RF) launch coupled to the radial parallel plate waveguide comprising
a rectangular waveguide having a radial non-symmetric mode,
a rectangular waveguide to coaxial stepped transition coupled to the rectangular waveguide and having a pin receptacle, and
a coaxial to radial transition coupled to the rectangular waveguide to coaxial stepped transition and having a radial symmetric mode, wherein the coaxial to radial transition has a pin that is coupled to the pin receptacle.

24. The antenna defined in claim 23 wherein the coaxial to radial transition has a coaxial with a dielectric constant that is higher than air and is configured to maintain the pin of the coaxial to radial transition in a centered position with respect to the coaxial to radial transition.

25. The antenna defined in claim 23 wherein the coaxial to radial transition comprises an interface shaped into concentric tiers.
